(19) United States
(12) Patent Application Publication
(10) Pub. No.: US 2009/0228904 A1
(43) Pub. Date: Sep. 10, 2009

(54) DECLARATIVE SUPPORT FOR ASYNCHRONOUS METHODS

(75) Inventors: Henricus Johannes Maria Meijer, Mercer Island, WA (US); John Wesley Dyer, Monroe, WA (US); Jeffrey Van Gogh, Redmond, WA (US); Danny Van Velzen, Redmond, WA (US); Harish Kantamneni, Redmond, WA (US); Dragos A. Manolescu, Kirkland, WA (US); Brian Beckman, Newcastle, WA (US); Benjamin Livshits, Kirkland, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/042,113

(22) Filed: Mar. 4, 2008

(51) Int. Cl. G06F 9/46

(52) U.S. Cl. 719/320

(57) ABSTRACT

Asynchronous methods and calls are produced automatically as a function of a declarative indication of intent. A method annotated with an asynchronous attribute or method call including a special asynchronous function can be identified. Subsequently, an asynchronous version of an identified synchronous method or call is generated automatically. Assistance is also provided for specifying intent.

### BACKGROUND

Computer programs are groups of instructions that describe actions to be performed by a computer or other processor-based device. When a computer program is loaded and executed on computer hardware, the computer will behave in a predetermined manner by following the instructions of the computer program. Accordingly, the computer becomes a specialized machine that performs the tasks prescribed by the instructions.

A programmer using one or more programming languages creates the instructions comprising a computer program. Typically, source code is specified or edited by a programmer manually and/or with help of an integrated development environment (IDE). Subsequently, the source code can be compiled or otherwise transformed by another program into computer instructions executable by a computer or like device.

For example, a programmer may choose to implemented code utilizing a high-level, object-oriented programming language (e.g., C#, C++, VB, Java . . . ). Executable code can then be produced for a particular machine utilizing an associated compiler. Alternatively, the code can be transformed into intermediate language (IL) code for a target virtual machine to facilitate execution on multiple computer platforms via further compilation or interpretation of the intermediate code.

Methods are a significant programmatic mechanism in most programming languages. Also referred to as a function in some scenarios, a method is an independent, reusable package of functionality. It specifies a specific task or routine to be performed. In the object-oriented paradigm, methods describe specific class behavior or abilities. For example, a class dog can have a method bark.

Most methods are conventionally synchronous in nature. Method interaction follows a caller/callee pattern, where the caller invokes functionality provided by the callee. In this case, a caller makes a call to the callee; the callee does some computation and then returns the results of the computation to the caller. The caller blocks while the callee performs some computation. However, this is problematic if computation takes a relatively long time to perform, for example, due to computational intensity or latency associated with a network or disk. This problem can be addressed utilizing an asynchronous method.

An asynchronous method does not block while a computation is performed. The caller simply continues and the callee starts. Once the callee is finished, a mechanism is employed for the caller and callee to synchronize again. For instance, the callee can call back to the caller. Stated differently, rather than being an asymmetrical call where the caller calls the callee and the caller blocks and waits, the caller calls the callee and the callee calls back to the caller with a result. Among other things, this enables specification of very responsive programs since the caller will typically not block.

To specify an asynchronous method, programmers need include quite a bit of plumbing code to inject asynchrony. In one conventional embodiment, this corresponds to creation of a delegate and definition of “BeginInvoke” and “EndInvoke” methods. Here, “BeginInvoke” initiates asynchronous operation and “EndInvoke” obtains a result. Asynchronous methods can be specified in a variety of manners utilizing this design pattern. For example, after initiation of an asynchronous operation “EndInvoke” can be called directly to obtain a result or indirectly by a callback function.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to generation of asynchronous methods and method calls. In accordance with an aspect of the disclosure, users can declare their intent that an asynchronous method be produced via code annotation. For example, a declarative attribute can be attached to a method that indicates that an asynchronous version of the method is desired. According to another aspect, a special function can be specified at a synchronous method call site to indicate a desire for an asynchronous call. Mechanisms are provided to automatically generate the asynchronous implementation or call. In other words, developers simply identify their intent and the implementation is automatically generated. As a result, developers can easily employ asynchronous methods to produce very responsive applications.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of an asynchronous method generation system according to an aspect of the disclosed subject matter.

FIG. 2 is a block diagram of a representative method annotation component in accordance with an aspect of the disclosure.

FIG. 3 is a block diagram of a representative asynchronous writer component according to a disclosed aspect.

FIG. 4 is a block diagram of a code transformation system in which asynchronous code is generated at an intermediate code level in accordance with an aspect of the disclosure.

FIG. 5 is a block diagram of a code transformation system that generates asynchronous code at a source code level according to a disclosed aspect.

FIG. 6 is a block diagram of a code transformation system that produces asynchronous code at execution time in accordance with an aspect of the disclosure.

FIG. 7 is a block diagram of a code loader system that generates asynchronous code according to an aspect of the disclosure.

FIG. 8 is a block diagram of an annotation specification system in accordance with a disclosed aspect.

FIG. 9 is a flow chart diagram of a method of declaring asynchronous methods according to an aspect of the disclosure.

FIG. 10 is a flow chart diagram of a method of asynchronous method generation in accordance with a disclosed aspect.

FIG. 11 is a flow chart diagram of a method of asynchronous call generation according to an aspect of the disclosure.

FIG. 12 is a flow chart diagram of an asynchronous annotation generation method in accordance with an aspect of the disclosure.

FIG. 13 is a schematic block diagram illustrating a suitable operating environment for aspects of the subject disclosure.

FIG. 14 is a schematic block diagram of a sample-computing environment.

### DETAILED DESCRIPTION

Systems and methods pertaining to asynchronous methods are described in detail hereinafter. Conventional code necessary to provide asynchronous methods/functions is tremendously arcane, and as a result, programmers rarely use such methods/functions, even when they really should. Consequently, many applications are much less responsive than possible or even hang because of communication failures, for instance.

Mechanisms are provided herein to facilitate and promote employment of asynchronous methods/functions. In particular, asynchrony is defined declaratively. In one instance, an attribute can be specified with respect to method/function declarations to indicate intent that an asynchronous version of the method/function be utilized. A special function can also be specified with respect to a synchronous call indicating a desire for an asynchronous call. An asynchronous method or method call can subsequently be generated automatically. Further yet, programmers can be aided by a mechanism that generates attributes or refactored code based on solicited and/or unsolicited user input.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

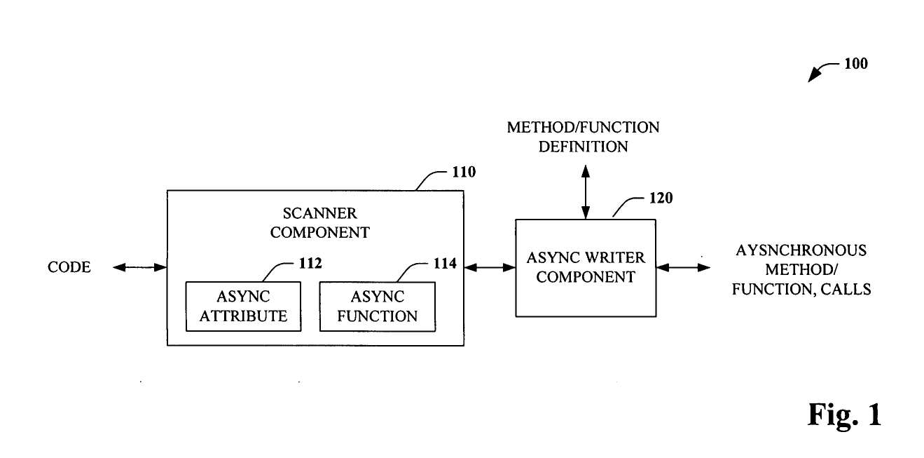

Referring initially to FIG. 1, an asynchronous method generation system 100 is illustrated in accordance with an aspect of the claimed subject matter. As shown, the system 100 includes a scanner 110 and an asynchronous (async) writer 120 both of which are components as defined herein. The scanner component 110 scans programmatic code for declarative indications of asynchronous intent associated with methods, functions, and/or calls thereto. More specifically, the scanner component 110 includes an asynchronous attribute component 112 as well as an asynchronous function component 112.

The asynchronous attribute component 112 facilitates identification of methods, functions or the like annotated with an asynchronous attribute such as “Async”, among other things. The scanner component 110 via attribute component 112 can identify methods or functions annotated with this attribute. For example, an asynchronous method declaration (empty) can include or otherwise be associated with an attribute “Async.” This attribute expresses the intent that an asynchronous version of a corresponding synchronous method is desired. In addition to the attribute, the scanner component 110 can also identify other associated information including an optional asynchronous implementation pattern that specifies details regarding the implementation of a desired asynchronous method.

The asynchronous function component 114 is a mechanism for aiding the scan component 110 in identifying specific synchronous method or function calls that should be converted/rewritten to asynchronous calls. Unlike method definitions or declarations, call sites can be identified by a special identifying function call such as “Async( )” rather than an attribute. The asynchronous function component 114 can be configured to identify these functions as well as the related calls. It is also to be appreciated that the call site identification function an also be annotated with special information regarding an implementation pattern. Accordingly, the scan component 110 can also identify this information as well.

Upon detection, the scanner component 110 can transmit or otherwise make accessible to the writer component 120 the identity of one or more methods, functions, and/or calls. Other information can also be provided to the writer component 120 including but not limited to implementation patterns, as will be described further in later sections.

Upon receipt or retrieval of scanner information, the writer component 120 can generate or produce an asynchronous version of a method, function, and/or call. Methods or functions can be generated as a function of the corresponding synchronous method as well as other attribute or annotation information including an implementation pattern, where available. In one implementation, the writer component 120 can rewrite an identified synchronous method from its actual definition or an expression tree representation and inject asynchronous mechanisms at appropriate locations. Calls can be rewritten into asynchronous calls in accordance with any provided implementation pattern. The particular asynchronous mechanisms or asynchronous patterns can include those known in the art.

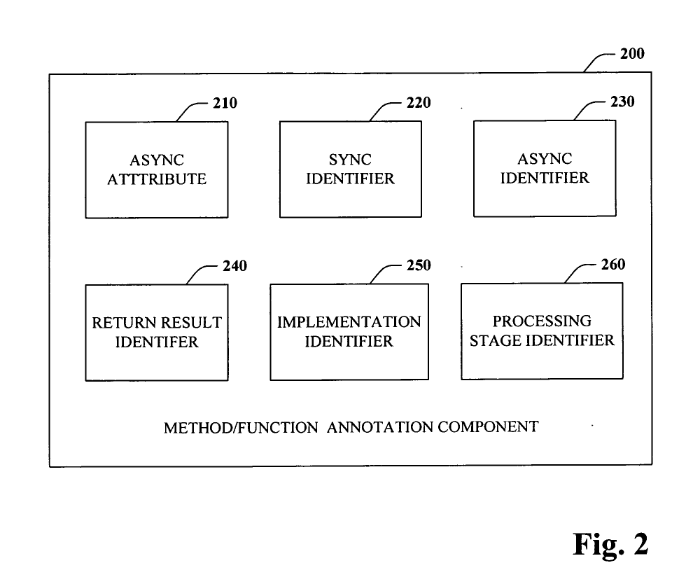

Turning to FIG. 2, a representative method annotation component 200 is depicted according to an aspect of the claimed subject matter. The annotation component 200 can be the input sought by the scanner component 110 of FIG. 1. Furthermore, the annotation component 200 comprises a number of sub-components including the async attribute 210, sync identifier 220, async identifier 230, result return identifier 240, implementation identifier 250, and processing stage component 260. The async attribute 210 corresponds to a unique attribute or identifier such as “Async” that denotes that an asynchronous method is desired. The sync identifier 220 identifies a synchronous method that is to be employed to generate an asynchronous method. For example, in “Async(“F”), “F” identifies a corresponding synchronous method. The async identifier 230 provides a name for a newly generated asynchronous method, where it differs from the synchronous name, for instance. The return result identifier 240 specifies a mechanism to employ for returning results such as callbacks, futures or any other type or mechanism that represents asynchronous computations. The implementation identifier 250 specified a desired asynchronous implementation or implementation idiom such as “BeginInvoke . . . EndInvoke” or XML HTTP requests, among others. The processing stage identifier 260 defines which stage or layer of processing the generation or transformation is to be performed. For example, this can correspond to source to intermediate language (IL) compilation, IL to IL transformation, loading, or just in time compiling (JITing), among others.

The representative annotation component 200 only provides as subset of possible sub-components. Of course, others are possible, contemplated and within the scope of the claimed subject matter. Furthermore, it is to be noted that the sub-components can be used or not used, combined or not combined in a variety of manners. For example, the async attribute 210 can be employed in conjunction with the sync identifier but not the async identifier 230. Alternatively, the async attribute 210 can be utilized in combination with async identifier 240 where the sync identifier is inferred from the async identifier, perhaps by the scanner component 110 of FIG. 1 or a sub-component thereof.

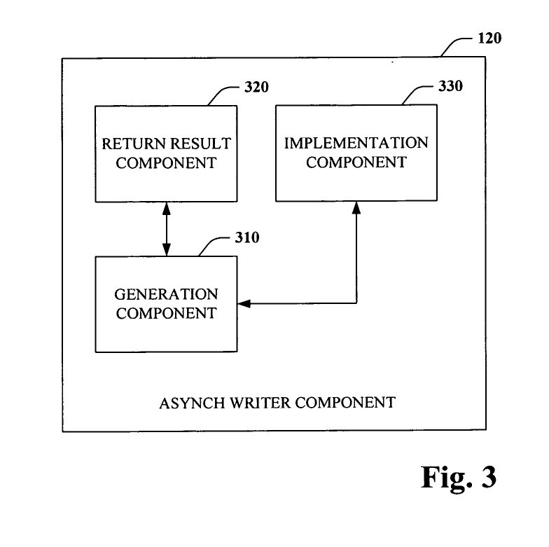

FIG. 3 depicts a representative asynchronous writer component 120 in accordance with an aspect of the claimed subject matter. Generation component 310 produces an asynchronous method or call. In other words, the generation component 310 can rewrite a synchronous method or call into an asynchronous method or call by injecting asynchronous mechanisms at least some of which are known in the art. For methods in particular, the generation can be based on a related or corresponding synchronous method definition or implementation, which can be explicitly specified or otherwise determined or inferred. Furthermore, the generation component 310 can produce an asynchronous methods or calls as a function of additional declared properties, preferences or the like, thereby providing control over generation of asynchrony. Where such particulars are not explicitly declared, the generation component 310 can infer appropriate details as a function of context information.

As shown the generation component 310 can interact with the return result component 320. This component provides information to the generation component 310 to facilitate implementation of varying return result mechanisms. An important feature of asynchronous methods is the ability to call another method and, rather than block waiting for a response, continue processing and accept a result at a later time. These results can be provided by different return result mechanisms including but not limited to callbacks, futures or other types or mechanisms that represent asynchronous computations. In brief, a callback is a function passed to a method that can call back to the caller after a result is computed by a callee. By contrast, a future is an object that acts as a placeholder for a result of a method invocation. When a caller calls a callee rather than waiting for a response a future object is returned which is a placeholder for the result of a computation allowing computation to continue to be performed by the caller.

The generation component 310 can also utilize information provided by implementation component 330 to generate asynchronous methods. Based on a given programmatic context different implementations of asynchronous methods can be required or preferred. For example, one conventional implementation pattern is referred to as “BeginInvoke and EndInvoke.” Here, a delegate is created and invocation is broken up into begin and end operations. While this may be useful in many situations, it may not be the best for dealing with network transactions. In this case, an XML HTTP request pattern can be utilized instead. The implementation component 330 provides generation component 310 with information pertinent to generation of specific implementations as needed.

Interactions with the implementation component 330 can be governed by an annotation. However, where such information is not explicitly provided, the generation component 310 can employ a default implementation or infer appropriate settings based on available context information. For instance, if it is known or it can be inferred that the associated application or pertinent portion thereof deals with network transactions, the generation component 310 can interact with implementation component 330 to aid generation of an asynchronous method utilizing an XML HTTP request pattern.

For purposes of clarity, a few examples are presented aid description of aspects of the claimed subject matter. These are only examples. They are not meant to limit the scope of invention thereto but rather aid understanding of some aspects. The first example pertains to method generation with respect to callees and the second example concerns callers.

Consider first the following synchronous method written in a high-level structured programming language: “public Int F (string s).” In this case, the synchronous function “F” is passed a string “s” and returns an integer. Where one desires to utilize an asynchronous version of that method, the following can be specified:

[Async (“F”)]
public extern void Foo (string s, Action<int> callback);

Here, the asynchronous attribute is “Async” and the synchronous method identifier is “F.” Other identifiers are provided in an asynchronous method signature or declaration below the asynchronous attribute and synchronous method identifier. In this case, the asynchronous identifier is “Foo” and the return result mechanism is callback. Stated differently, an asynchronous version of the method “F” named “Foo” is desired that utilizes a callback mechanism to provide the result. In operation, a caller passes the callee method “Foo” a callback function that takes an integer together with a string, and the callee invokes the function when computation is complete. While not shown here, it should also be noted that the asynchronous method signature can include another callback, namely a failure callback that can be called if the asynchronous method fails due to a computational or network failure, for example. Typically, if you are executing within the same thread and a failure occurs, an exception is thrown. However, since the asynchronous code is not running in the same thread, the code may not be aware of a bubbled up exception. The failure callback is a mechanism that can provide notification of such an exception.

In response to the above declared intent, the method body can be automatically generated as follows:

```
[Async(“F”)]
public void Foo(string s, Callback<int> callback)
{
    object[ ] parameters = new object[ ] { s };
    Proxy.AsyncCall<int>(callback, “http://localhost:8081/C.agi”, 2,
new Guid?(this._instance), parameters);
}
```

Notice in this simplified example the implementation calls a server-side “F,” but it does it asynchronously. In the end, users need only specify “what” and the “how” is automatically injected.

In the first example, the annotation was applied on a method. This assumes control over a location in which both the synchronous and asynchronous methods are defined. Accordingly, a library writer that would like to provide the ability to make synchronous and asynchronous calls could do so in this manner. Synchronous methods would be defined and then asynchronous methods defined without an implementation but with a declarative annotation. Unfortunately, this approach may not be appropriate if someone wants to call third party code in an asynchronous way since there is no access to the relevant code. In this case, call side annotation can be utilized.

The second example pertains to such call side annotation. Consider, for instance, a synchronous method call “x=c.F( . . . ).” To transform this call to an asynchronous one an identifying method/function such as “Async” can be included as in “x=Async(c.F( . . . )).” The asynchronous method can be denoted as follows:
Future<T> Async<T> (T value) {return new Future<T>(value);}
   In other words, it performs synchronously. However, call-sites can be transformed to make them run asynchronously as follows:
x=new Future<T>(( )=>c.F( . . . ));
   Instead of making the call, a future construct is inserted and passed the synchronous call. Then, if “x” is not used until later, this code will run asynchronously and not block until the value of “x” is required. Here, “Future<T> can be used in place of “T” and acts as a thunk.

In accordance with another aspect of the disclosure, it is to be appreciated that a call site identification function can be annotated with information to identify an implementation pattern, among other things. For example:

[AsyncCallSite(...implementation/optional...)]
public extern Future<T> Async<T>(T t)

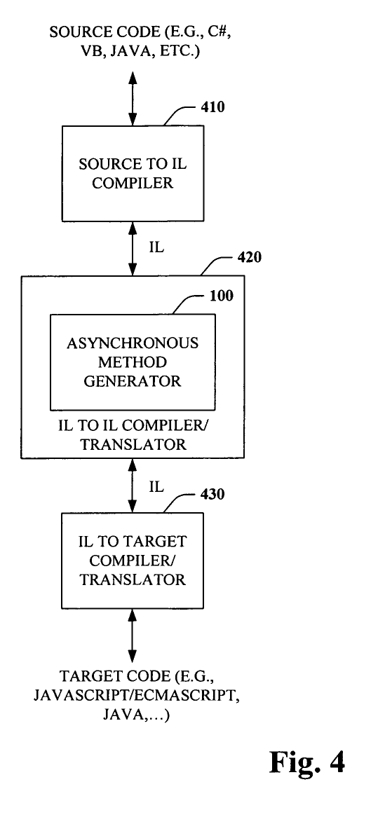

Automatic generation or transformation can be performed at various programmatic levels. The level can be dictated by a particular embodiment. However, programmers can influence the level utilized for transformation by providing a processing identifier, as previously described. FIGS. 4-7 illustrate a few different exemplary embodiments. Of course, these embodiments are not exhaustive, and other embodiments are also possible.

Turning to FIG. 4, a code transformation system 400 is illustrated in accordance with an aspect of the claimed subject matter. Source code specified in one or more programming languages (e.g., C#, VB, Java, C++ . . . ) can be provided or otherwise acquired by the source to IL compiler component 410. Subsequently, the source to IL compiler 410 can compile or transform the source code to intermediate language (IL) code. IL to IL compiler/translator component 420 can provide further processing of IL code. Here, the IL to IL compiler/translator 420 includes the asynchronous method generation system 100, as previously described, as a sub-component. Accordingly, code can be injected to provide an implementation for methods or method calls identified as asynchronous that lack such implementation. Subsequently, the IL code can be compiled or translated into target code by the IL to target compiler/translator component 430. In one particular implementation, the IL code can be transformed into a language such as ECMAScript (JavaScript, JScript . . . ) for interpretation and execution within a web browser.

Invoking asynchronous method generation at the IL level has a few advantages. First, developers can insert asynchronous annotations of syntax into any programming language that compiles to IL. This enables generation of asynchronous methods in many languages. Second, source code is not obfuscated by complexities of asynchrony. Rather, the code can simply include understandable declarative annotations. Third, this embodiment is stable. Programming languages such as those utilized to create source code continually evolve adding new features, but IL changes much less frequently, if at all. Furthermore, there is close to zero impact on tooling, which is tightly coupled to the language employed, since on the IL level all tooling is upstream.

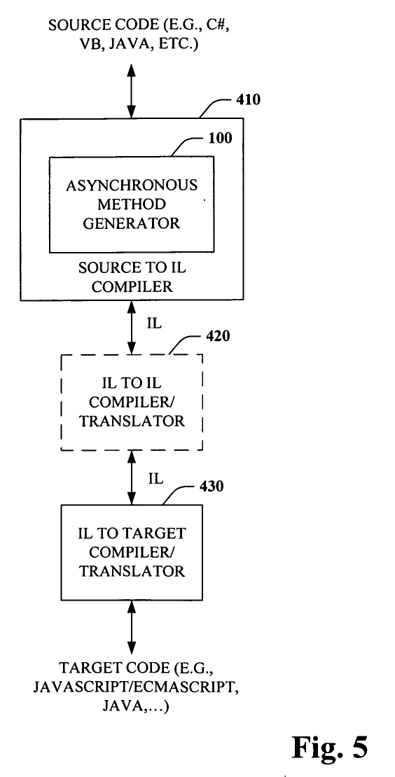

FIG. 5 illustrates a code transformation system 500 where asynchronous code generation/transformation is performed at a source code level. As shown, the system 500 includes a source to IL compiler 410. As previously described, the compiler 410 translates source code from one or more languages into intermediate language code. Additionally, the source to IL compiler 410 includes the asynchronous method generation system 100 as a component thereof. The compiler 410 is therefore able to generate implementations for asynchronous methods or calls to such methods in accordance with an annotation or other special syntax. These asynchronous implementations can then be translated into the intermediate language in the same way as other code. The generated IL can then be provided optionally to an IL to IL compiler/translator 420 to provide further transformations of IL code. The resultant IL code can act as input for an IL to target language compiler/translator 430. For example, the IL can be compiled into a scripting language for execution in a web browser. Implementation of this embodiment can result in production of asynchronous method generation components 110 for each language compiler.

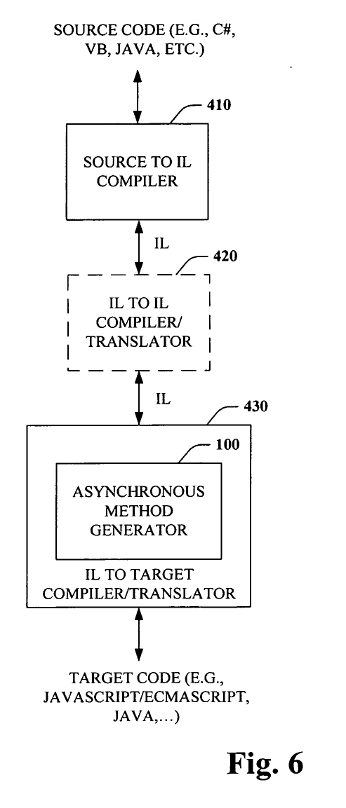

Turning attention to FIG. 6, a code transformation system 600 is depicted in accordance with an aspect of the claimed subject matter. The system 600 can include the source to IL compiler 410 and IL to IL compiler/translator 420, as previously described. Further, the system 600 includes the IL to target compiler/translator component 430. In this embodiment, the asynchronous method generation system 100 can be a component of the IL to target compiler translator component 430. In one instance, component 430 can correspond to a just in time (JIT) compiler. Accordingly, asynchronous implementations can be injected dynamically at runtime in accordance with asynchronous annotations or other special syntax.

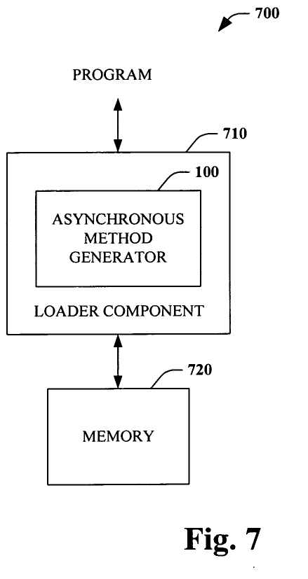

FIG. 7 illustrates a program loader system 700 in accordance with an aspect of the claimed subject matter. The loader system 700 includes a loader component 710 that receives or otherwise acquires an executable computer program and loads it into memory 720. This prepares a program for subsequent execution from the memory 720. Unlike conventional systems, the loader component 710 includes the previously described asynchronous method generation system 100 as a component. Prior to loading in memory, asynchronous method implementations and/or calls can be injected in accordance with declarative annotation and/or call site identification functions, respectively.

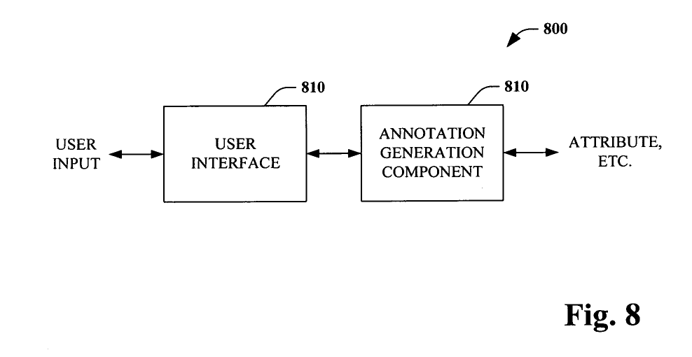

Referring to FIG. 8, annotation specification system 800 is provided in accordance with an aspect of the claimed subject matter. The system 800 includes a user interface component 810 and an annotation generation component 820. The user interface component 810 facilitates user interaction with the system 800. More specifically, information pertaining to declaratively identifying asynchronous methods and/or calls can be afforded to and/or acquired from users. The annotation generation component 820 produces attributes or annotations required for generation of asynchronous methods and/or calls in accordance with a claimed aspect of this disclosure. The annotation generation component thus provides code refactoring functionality.

The annotation generation component 820 can acquire information for generation of attributes or annotations passively or actively. For instance, the user interface component 810 can simply act as a mechanism for receiving and passing information to the annotation generation component 820. Alternatively, the annotation generation component 820 can actively solicit information from users via the user interface component 81 0. By way of example, the annotation generation component 820 can act as a wizard that requests information such as synchronous method name, asynchronous method name, return result mechanism, and/or asynchronous implementation idiom. In one embodiment, the system 800 can be or form part of one or more development tools. As a result, declaration of asynchrony can be made even easier than direct specification.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the asynchronous component 120 can utilize such mechanism to infer or otherwise determine attribute information not explicitly provided. For instance, where an asynchronous attribute is specified with an asynchronous method signature but without a synchronous name, it can be inferred that the asynchronous and synchronous method names are the same.

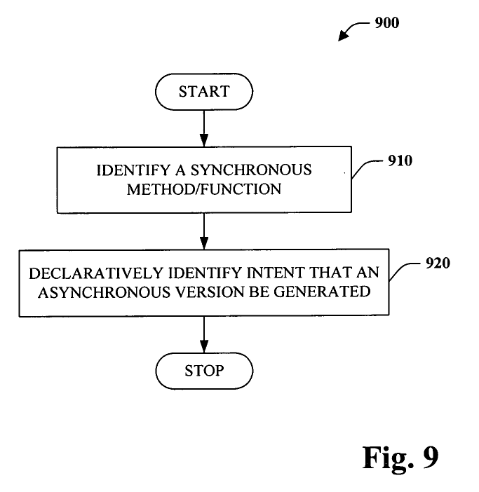

In view of the exemplary systems described supra, methodologies that may be implemented in accordance with the disclosed subject matter will be better appreciated with reference to the flow charts of FIGS. 9-11. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 9, a method of asynchronous method declaration 900 is depicted in accordance with an aspect of the claimed subject matter. At reference numeral 910, a synchronous method (or function) is identified. The identified method corresponds to a method on which asynchronous communication is desired. At numeral 920, asynchronous intent is declaratively identified in relation to the identified method indicative of the desire for an asynchronous version. This can be accomplished by providing specialized syntax or an annotation on a method or method declaration. For example, an attribute “Async” can be attached to a synchronous method definition or alternatively an empty declaration of an asynchronous method. The attribute alone or in combination with other information associated therewith that can influence generation of an asynchronous method such as asynchronous method name, return result mechanism, and implementation idiom, among others. It is to be appreciated that method calls can be declared and generated in a similar manner except that rather than utilizing an attribute, a special function call such as “Async( . . . )” is present at an synchronous call site indicating an intent that the call be performed asynchronously as opposed to synchronously.

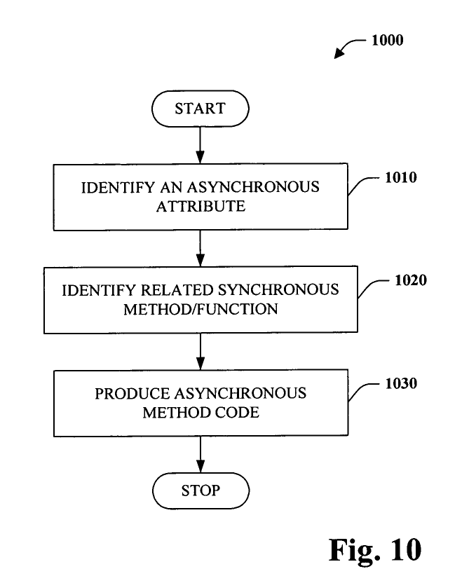

FIG. 10 illustrates a method of asynchronous method generation 1000 according to an aspect of the subject claims. At reference numeral 1010, an asynchronous method attribute is identified. For example, a program can be scanned for an attribute named “Async” or the like attached to a method definition or declaration. At numeral 1020, a related synchronous method/function is identified. Where the asynchronous attribute is attached directly to a synchronous method definition, the synchronous method can be easily identified. In another implementation, further information associated with the attribute can be retrieved to identify such method. For example, “Async “F” can indicate that an asynchronous version of the synchronous method named “F” is desired. If the synchronous method name is not explicitly identified it can be inferred for instance based on an asynchronous method signature, among other things. At reference 1030, the asynchronous method code is produced as a function of the asynchronous attribute, and other associated information, as well as the related synchronous method. Stated differently, a synchronous method is transformed into an asynchronous method via injection of asynchronous mechanisms in accordance with an annotation.

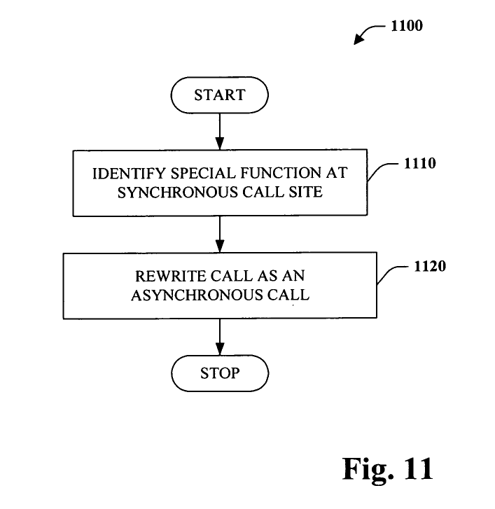

Referring to FIG. 11, a flow chart diagram illustrates a method 1100 of asynchronous call generation. At reference numeral 1110, the special function is identified at a synchronous call site. For example, the function can be “Async( )” as in “x=Async(c.F( . . . )).” The type of the function is “Future<T> Async<T>(T t)” or some other representation of asynchronous computations. At reference numeral 1120, the call is rewritten as an asynchronous call. Stated differently, an asynchronous call is generated an injected. For instance, “x=Async(c.F( . . . ))” can be rewritten as “x=new Future<T>(( )=> c.F( . . . )).

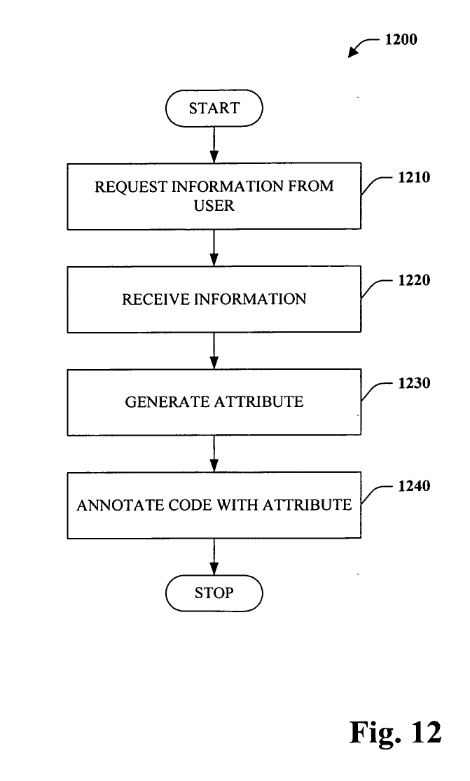

Turning attention to FIG. 12, a flow chart diagram is provided illustrating a method 1200 of asynchronous annotation generation in accordance with an aspect of the claimed subject matter. In accordance with one embodiment, method 1200 can be performed by one or more development tools associated with an integrated development environment (IDE). At reference numeral 1210, information regarding asynchrony is requested from a user. For example, such request can include identification of a corresponding synchronous method and details regarding a desired implementation, among other things. At reference 1220, information is received from a user. This information can be that requested by act 1210 or unsolicited information. At numeral 1230, an attribute is generated in accordance with received information. The attribute can include a variety of information including preferences regarding implementation. In the simplest case, however, it can simply be an identifier such as “Async.” At reference numeral 1240, programmatic code is annotated with the attribute and any related information/parameters.

Overall, the method 1200 helps facilitate code annotation and more specifically asynchronous method generation/transformation. By way of example, in an IDE a user can right click on a method to initiate refactoring into or generation of an asynchronous version of the method. The IDE can then attach an asynchronous attribute to the method. Further yet, right-clicking can cause a dialog box to be spawned that asks the user questions like: Do you want the asynchronous version to have a different name or the same name? Do you want to use a callback mechanism or futures? What design pattern or idiom do you want employed for the underlying implementation? An annotation can then be produced that captures all such user provided information. Otherwise, defaults can be employed or optimum parameters inferred as a function of contextual information.

The terms “method” and “function” are utilized interchangeably herein. A “function” conventionally refers to a piece of code that performs an operation. On the other hand, a “method” is a function on an object. In practice as well as herein, however, the terms are used interchangeably to refer simply to a piece of code that specifies a specific routine or operation regardless of whether an object is involved or not.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

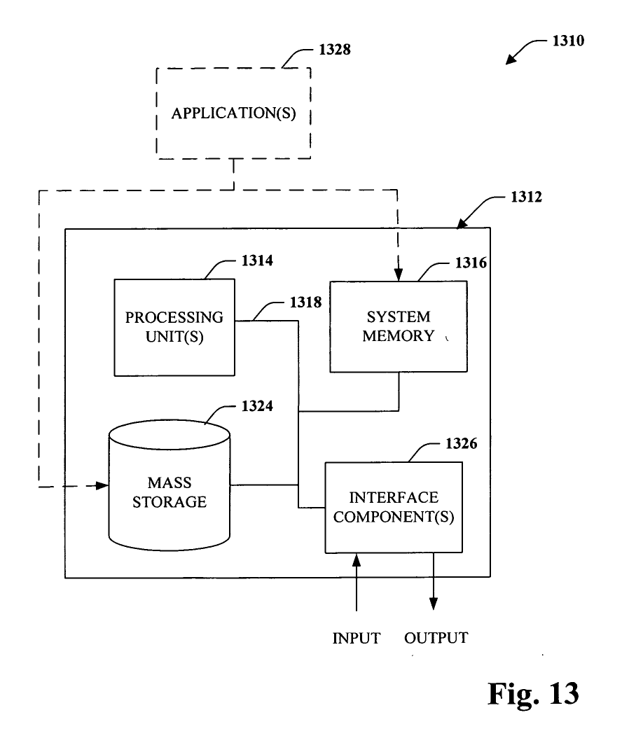

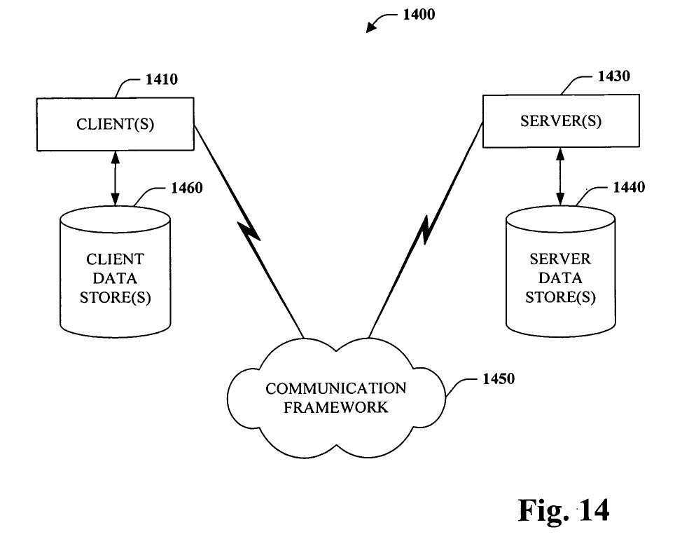

In order to provide a context for the various aspects of the disclosed subject matter, FIGS. 13 and 14 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 13, an exemplary environment 1310 for implementing various aspects disclosed herein includes a computer 1312 (e.g., desktop, laptop, server, hand held, programmable consumer or industrial electronics . . . ). The computer 1312 includes a processing unit 1314, a system memory 1316, and a system bus 1318. The system bus 1318 couples system components including, but not limited to, the system memory 1316 to the processing unit 1314. The processing unit 1314 can be any of various available microprocessors. It is to be appreciated that dual microprocessors, multi-core and other multiprocessor architectures can be employed as the processing unit 1314.

The system memory 1316 includes volatile and nonvolatile memory. The basic input/output system (BIOS), containing the basic routines to transfer information between elements within the computer 1312, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1312 also includes removable/non-removable, volatile/non-volatile computer storage media. FIG. 13 illustrates, for example, mass storage 1324. Mass storage 1324 includes, but is not limited to, devices like a magnetic or optical disk drive, floppy disk drive, flash memory, or memory stick. In addition, mass storage 1324 can include storage media separately or in combination with other storage media.

FIG. 13 provides software application(s) 1328 that act as an intermediary between users and/or other computers and the basic computer resources described in suitable operating environment 13 10. Such software application(s) 1328 include one or both of system and application software. System software can include an operating system, which can be stored on mass storage 1324, that acts to control and allocate resources of the computer system 1312. Application software takes advantage of the management of resources by system software through program modules and data stored on either or both of system memory 1316 and mass storage 1324.

The computer 1312 also includes one or more interface components 1326 that are communicatively coupled to the bus 1318 and facilitate interaction with the computer 1312. By way of example, the interface component 1326 can be a port (e.g., serial, parallel, PCMCIA, USB, FireWire . . . ) or an interface card (e.g., sound, video, network . . . ) or the like. The interface component 1326 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1312 to output device(s) via interface component 1326. Output devices can include displays (e.g., CRT, LCD, plasma . . . ), speakers, printers and other computers, among other things.

FIG. 14 is a schematic block diagram of a sample-computing environment 1400 with which the subject innovation can interact. The system 1400 includes one or more client(s) 1410. The client(s) 1410 can be hardware and/or software (e.g., threads, processes, computing devices). The system 1400 also includes one or more server(s) 1430. Thus, system 1400 can correspond to a two-tier client server model or a multi-tier model (e.g., client, middle tier server, data server), amongst other models. The server(s) 1430 can also be hardware and/or software (e.g., threads, processes, computing devices). The servers 1430 can house threads to perform transformations by employing the aspects of the subject innovation, for example. One possible communication between a client 1410 and a server 1430 may be in the form of a data packet transmitted between two or more computer processes.

The system 1400 includes a communication framework 1450 that can be employed to facilitate communications between the client(s) 1410 and the server(s) 1430. The client(s) 1410 are operatively connected to one or more client data store(s) 1460 that can be employed to store information local to the client(s) 1410. Similarly, the server(s) 1430 are operatively connected to one or more server data store(s) 1440 that can be employed to store information local to the servers 1430.

Client/server interactions can be utilized with respect with respect to various aspects of the claimed subject matter. By way of example and not limitation, method calls can be performed between a client 1410 and a server 1430 across the communication framework 1450. Moreover, disclosed aspects can be incorporated into a specific compiler or translator that performs tier splitting on a client 1410 or server 1430 in which application code is split or distributed for execution across one or more clients 1410 and servers 1430. This can enable developers to write powerful multi-tiered code easily while preserving essential program semantics like object identity.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. An asynchronous method and/or call generation system, comprising:
a scanner component that locates a method and/or method call including a declaration of asynchronous intent; and
a writer component that generates an asynchronous version of the located method and/or call.

2. The system of claim 1, the declaration is an asynchronous attribute attached to an empty asynchronous method declaration.

3. The system of claim 2, the attribute and/or declaration identifies a desired asynchronous implementation pattern employed by the writer component.

4. The system of claim 2, the writer component generates an asynchronous method implementation as a function of a corresponding synchronous method definition.

5. The system of claim 4, the attribute and/or attached declaration identifies the synchronous method definition.

6. The system of claim 4, the writer component infers the corresponding method definition from the attribute and/or the asynchronous method declaration.

7. The system of claim 1, the declaration is a function at a synchronous call site.

8. The system of claim 1, the components form part of an intermediate language to intermediate language translator.

9. The system of claim 1, the components form part of a source code to intermediate language compiler, an intermediate language to machine language translator, or a program loader.

10. The system of claim 1, further comprising:
a user interface component that acquires information from a user; and
a generator component that generates an attribute and related parameters as a function of the acquired information.

11. A method of asynchronous method generation, comprising:
identifying an annotation attached to an asynchronous method declaration; and
producing an asynchronous method implementation automatically as a function of the annotation and a corresponding synchronous method.

12. The method of claim 11, further comprising identifying the corresponding synchronous method from the annotation.

13. The method of claim 11, further comprising inferring the corresponding synchronous method from the asynchronous method declaration.

14. The method of claim 11, comprising producing the asynchronous method in accordance with an implementation pattern specified by the annotation.

15. The method of claim 11, comprising inferring an implementation pattern as a function of context and producing the asynchronous method in accordance with the pattern.

16. The method of claim 11, comprising producing the asynchronous method at a processing stage designated by the annotation.

17. The method of claim 11, comprising identifying the annotation in intermediate language code and producing the method in intermediate language code.

18. A computer readable medium having stored thereon a computer program comprising:
a synchronous method; and
an identifier that indicates that an asynchronous version of the method or call thereto is desired.

19. The computer readable medium of claim 18, the identifier is an attribute attached to a synchronous method definition or an asynchronous method declaration.

20. The computer readable medium of claim 18, the identifier is special function located at a synchronous method call site.
